(19) United States
(12) Patent Application Publication
(10) Pub. No.: US 2010/0014508 A1
(43) Pub. Date: Jan. 21, 2010

(54) Method And System For Emergency Call

(75) Inventor: Yanfei Yang, Shenzhen (CN)

Correspondence Address: HARNESS, DICKEY & PIERCE, P.L.C., P.O. BOX 828, BLOOMFIELD HILLS, MI, 48303, US

(73) Assignee: HUAWEI TECHNOLOGIES CO., LTD., Shenzhen (CN)

(21) Appl. No.: 12/203,538

(22) Filed: Sep. 3, 2008

Related U.S. Application Data
(63) Continuation of application No. PCT/CN2007/000693, filed on Mar. 5, 2007.

(30) Foreign Application Priority Data
Mar. 3, 2006 (CN) 200610058358.5

(51) Int. Cl. H04L 12/66; H04M 11/04

(52) U.S. Cl. 370/352; 379/37; 455/404.1

(57) ABSTRACT

An emergency call includes sending, by a Call Session Control Function entity (CSCF) to User Equipment (UE), a session reject message containing indication information indicating re-initiating an emergence call according to a local policy upon detecting that a session request sent by the UE is an emergency session request; and re-initiating, by the UE, an emergency call of CS domain or Internet Protocol Multimedia Subsystem (IMS) domain according to the indication information. A system for an emergency call includes UE and a CSCF. The CSCF includes an emergency call determination unit and an emergency call domain selection unit. Upon detecting that a call is an emergency call, the CSCF instructs the UE to re-initiate an emergency call of CS or IMS domain according to whether a network supports the emergency call of CS or IMS domain.

### CROSS-REFERENCE TO RELATED APPLICATIONS

This application is a continuation of International Application No. PCT/CN2007/000693, filed Mar. 5, 2007. This application claims the benefit of Chinese Application No. 200610058358.5, filed Mar. 3, 2006. The disclosures of the above applications are incorporated herein by reference.

### FIELD

The present disclosure relates to the mobile communication technologies, and more particularly, to a method and system for an emergency call.

### BACKGROUND

The statements in this section merely provide background information related to the present disclosure and may not constitute prior art.

Internet Protocol Multimedia Subsystem (IMS) is a subsystem supporting Internet Protocol (IP) multimedia services, and is proposed by the 3rd Generation Partnership Project (3GPP) in Release 5 (R5). The IMS is characterized in that Session Initiation Protocol (SIP) is used and the IMS is access agnostic. The IMS is a multimedia control/call control platform in a Packet-Switched (PS) domain, supports session multimedia services and non-session multimedia services, and provides a common service platform for future multimedia applications. The IMS may be conveniently applied to real-time user-to-user mobile services, such as multimedia voice and video telephone services. The IMS supports user-to-user communication services through a series of mechanisms including: session negotiation and management, Quality of Service (QoS) and mobility management. With the IMS technology, operators may provide a non-real-time user-to-user service, e.g. chatting and instant messaging, a multi-user service such as multimedia conference and chatting room, and a server-to-user service such as dynamic push service and click to dial service.

The emergency call is a voice service function specified in the mobile communication system. After a user dials some special numbers such as 110, 119 and 120, the call will be forwarded to the corresponding Public Safety Answering Point (PSAP) such as police stations, fire departments and first aid centers as long as the user is located in the area covered by the mobile network. Therefore, the 24-hour emergency aid service can be provided to users. Operations of the entire system are implemented jointly by such emergency service departments as telecom operators, fire departments, hospitals and other public service departments.

Generally, the emergency call is implemented in the Circuit-Switched (CS) domain. While more and more networks adopt the IP technology, the PS domain starts to support the emergency call service gradually, and uses the IMS system to control call signaling for the emergency session. Currently, the emergency call service which is provided through the IMS domain can be called IMS Emergency Call (IMS-EMER) for short.

Hence, there is a need to improve the success rate of an emergency call for kinds of network situations.

### SUMMARY

Various embodiments provide a method and system for an emergency call to improve the success rate of an emergency call.

The technical scheme is described below.

A method for an emergency call includes:

sending, by a Call Session Control Function entity (CSCF) to User Equipment (UE), a session reject message containing indication information indicating re-initiating an emergence call according to a local policy upon detecting that a session request sent by the UE is an emergency session request; and

re-initiating, by the UE, an emergency call of CS domain or Internet Protocol Multimedia Subsystem (IMS) domain according to the indication information.

A system for an emergency call includes: User Equipment (UE) and a Call Session Control Function entity (CSCF). The CSCF includes: an emergency call determination unit and an emergency call domain selection unit;

the UE is configured to initiate a session request to the emergency call determination unit, and re-initiate an emergency call of CS domain or IMS domain according to a session reject message sent by the emergency call domain selection unit;

the emergency call determination unit is configured to forward the session request sent by the UE to the emergency call domain selection unit upon determining that the session request initiated by the UE is an emergency session request; and

the emergency call domain selection unit is configured to send to the UE the session reject message containing indication information indicating re-initiating an emergency call according to a local policy upon receiving the session request sent by the emergency call determination unit.

A Call Session Control Function entity (CSCF) includes one or more components configured to send a session reject message containing indication information indicating re-initiating an emergence call according to a local policy upon detecting that a session request received is an emergency session request.

In the various embodiments, upon detecting that the session request sent by the UE is an emergency session request, the CSCF sends to the UE a session reject message containing the indication information indicating re-initiating an emergency call of CS domain or IMS domain according to its configured local policy. Upon receiving the session reject message, the UE re-initiates an emergency call of CS domain or IMS domain according to the indication information. Upon detecting that the current call is an emergency call, the network indicates the UE to re-initiate an emergency call of CS domain or IMS domain according to whether the current network supports the emergency call of CS domain or IMS domain, avoiding the emergency session failure caused by sending an indication for re-initiating an emergency call of CS domain only and improving the success rate of emergency call. Thereby, the emergency call procedure in the prior art is improved.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a flowchart of emergency call messages when UE detects that a call initiated by a user is an emergency call;

FIG. 2 is a first flowchart of emergency call messages when UE can not detect that a call initiated by a user is an emergency call;

FIG. 3 is a second flowchart of emergency call messages when UE can not detect that a call initiated by a user is an emergency call;

FIG. 4 is a flowchart of an emergency call when UE can not detect that a call initiated by a user is an emergency call in accordance with various embodiments;

FIG. 5 is a flowchart of an emergency call when UE can not detect that a call initiated by a user is an emergency call in accordance with various embodiments;

FIG. 6 is a flowchart of an emergency call when UE can not detect that a call initiated by a user is an emergency call in accordance with various embodiments;

FIG. 7 is a block diagram illustrating a system for an emergency call in accordance with various embodiments; and

FIG. 8 is a block diagram illustrating a system for an emergency call in accordance with various embodiments of the present invention.

### DETAILED DESCRIPTION

The following description is merely exemplary in nature and is not intended to limit the present disclosure, application, or uses.

The various embodiments will be hereinafter described in detail with reference to accompanying drawings.

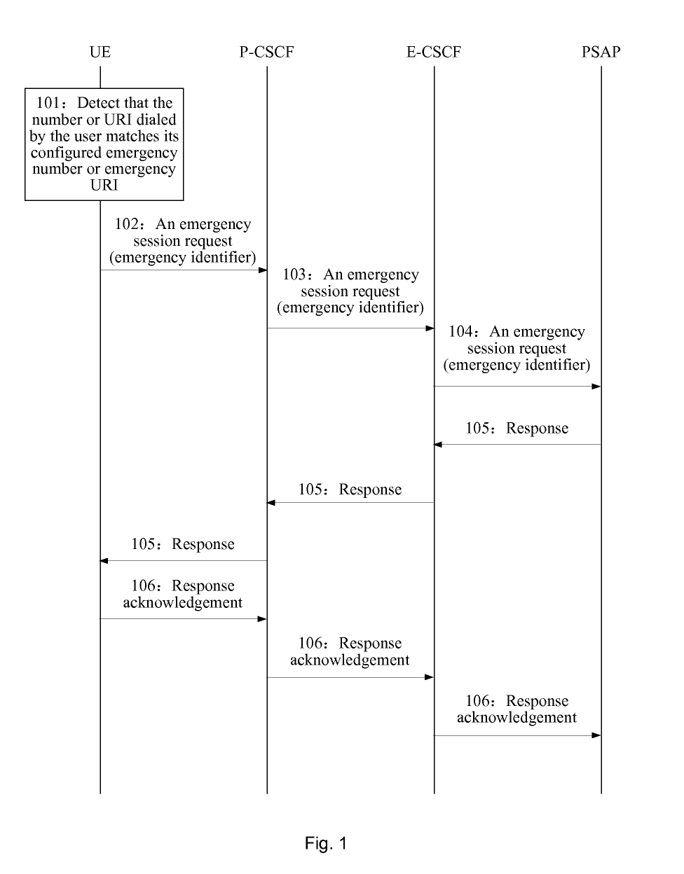

There are two cases of emergency session in the IMS domain. In one case, User Equipment (UE) detects that a call initiated by a user is an emergency call after the user dials an emergence, or emergency, number or emergence, or emergency, Uniform Resource Identifier (URI). FIG. 1 shows the flowchart of emergency call messages in this case. As shown in FIG. 1, the flowchart is described below.

In Actions 101-103, upon detecting that the number or URI dialed by a user matches the emergency number or emergency URI that is configured by the UE, the UE sends an emergency session request message containing an emergency identifier to Emergency Call Session Control Function entity (E-CSCF) through Proxy Call Session Control Function entity (P-CSCF).

In Actions 104-106, upon receiving the emergency session request message, the E-CSCF forwards the emergency session request message to a corresponding PSAP; the corresponding PSAP sends a response message to the UE through the E-CSCF and the P-CSCF; the UE sends a response acknowledgement message to the corresponding PSAP through the P-CSCF and the E-CSCF; and the emergency session is established after the corresponding PSAP receives the response acknowledgement message.

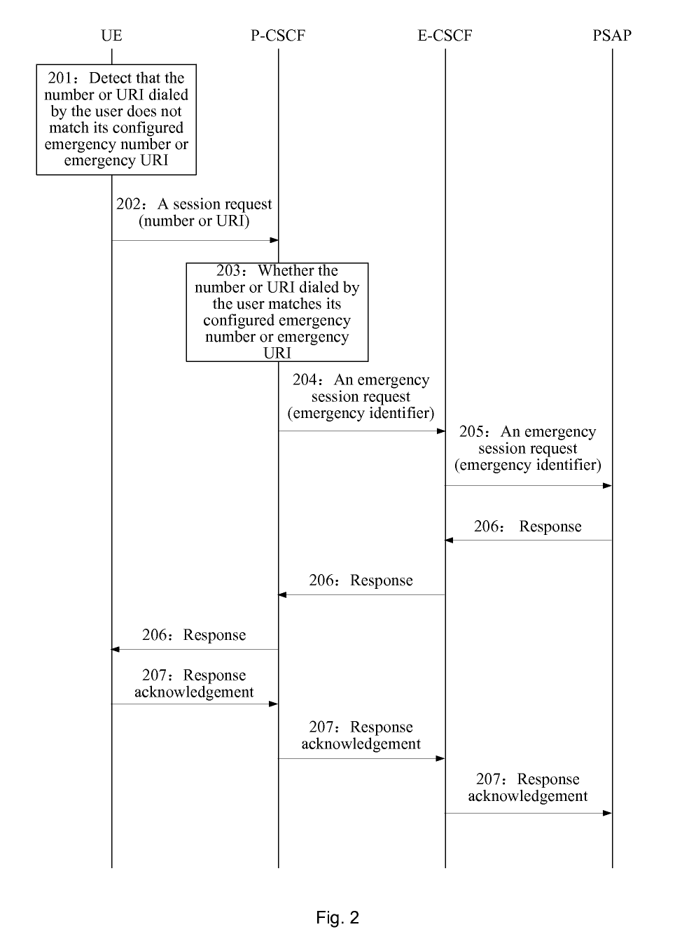

In the other case, the UE can not detect that the call initiated by the user is an emergency call after the user dials an emergency number or emergency URI. In this case, a first processing manner in the network is shown in FIG. 2, and is described below.

In Actions 201-202, upon detecting that the number or URI dialed by a user does not match the emergency number or emergency URI that is configured by the UE, the UE sends to the P-CSCF a session request message containing the number or URI dialed by the user.

The session request is a common session request, and the session request message contains no emergency identifier.

When the UE roams from the home network to the visited network and the emergency number of the area where the visited network is located is different from that of the area where the home network is located, the UE can not detect that the number dialed by the user is an emergency number after the user dials in the visited network the emergency number of the area where the visited network is located, this is because the emergency number saved by the UE itself is the emergency number of the area where the home network is located.

In Action 203, upon receiving the session request message, the P-CSCF determines whether the number or URI contained in the session request message matches the emergency number or emergency URI configured by the P-CSCF. If yes, Action 204 is performed; otherwise, the P-CSCF establishes the session according to the common session procedure, and terminates the flowchart.

In Actions 204-207, the P-CSCF sends an emergency session request message containing an emergency identifier to the E-CSCF; the E-CSCF forwards the emergency session request message to the PSAP; then the PSAP sends a response message to the UE through the E-CSCF and the P-CSCF, and the UE sends a response acknowledgement message to the PSAP through the P-CSCF and the E-CSCF. The emergency session is established after the PSAP receives the response acknowledgement message.

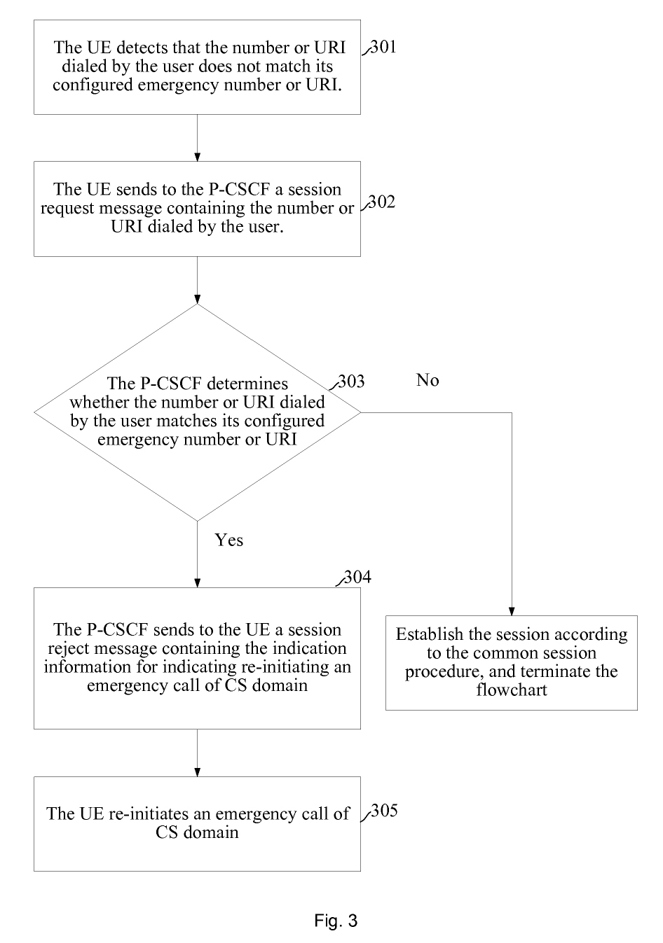

If the UE can not detect that the call initiated by the user is an emergency call after the user dials an emergency number or emergency URI, according to a second processing manner in the network, a session reject message is sent to the UE to indicate re-initiating an emergency call of CS domain. FIG. 3 shows the flowchart of the second processing manner. Referring to FIG. 3, the flowchart is described below.

In Action 301, upon detecting the number or URI dialed by a user, the UE detects that the number or URI does not match the emergency number or emergency URI configured by the UE.

In Action 302, the UE sends to the P-CSCF a session request message containing the number or URI.

The session request is a common session request, and the session request message contains no emergency identifier.

In Action 303, upon receiving the session request message, the P-CSCF determines whether the number or URI contained in the session request message matches the emergency number or emergency URI configured by the P-CSCF. If yes, Action 304 is performed; otherwise, the P-CSCF establishes the session according to the common session procedure, and terminates the flowchart.

In Action 304, the P-CSCF sends to the UE a session reject message containing an indication message for indicating re-initiating an emergency call of CS domain.

In Action 305, upon receiving the session reject message, the UE re-initiates an emergency call of CS domain according to the indication message contained in the session reject message for indicating re-initiating an emergency call of CS domain.

As can be seen from the flowchart shown in FIG. 3, upon detecting that the call initiated by the UE is an emergency call, the P-CSCF will notify the UE to re-initiate an emergency call of CS domain, and the UE performs the emergency session of CS domain again. As a result, if the CS domain does not support an emergency call, the emergency call would fail. At the same time, if the IMS domain supports an emergency call, the UE initiates an emergency call of CS domain rather than an emergency call of IMS domain, which will reduce the success rate of an emergency call. So an improved solution for emergency call is provided.

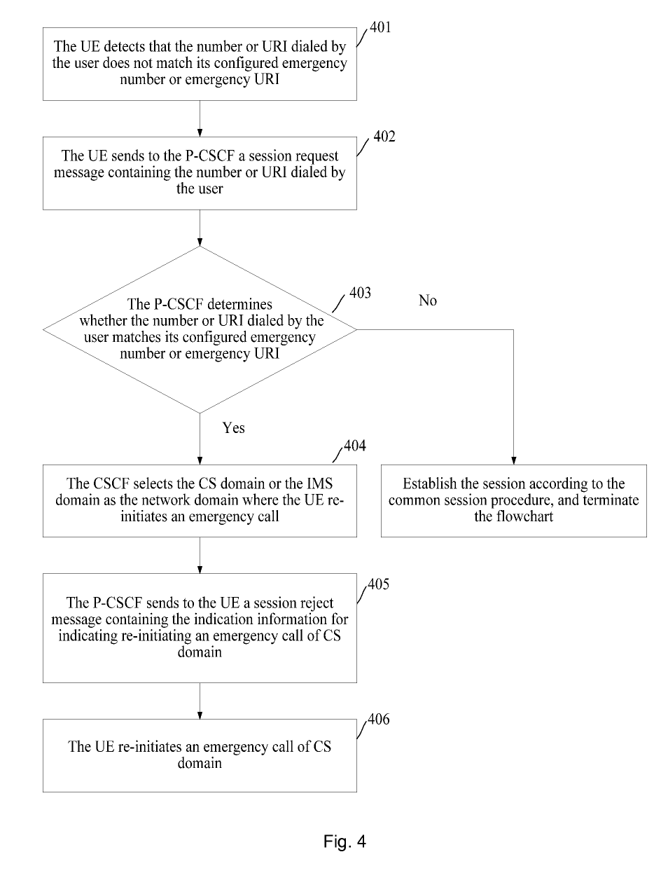

FIG. 4 is a flowchart of an improved method for emergency call when UE can not detect that a call initiated by a user is an emergency call in accordance with various embodiments. As shown in FIG. 4, the flowchart is described below.

In Action 401, upon detecting the number or URI dialed by a user, the UE further detects that the number or URI does not match its configured emergency number or emergency URI.

In Action 402, the UE sends to the CSCF a session request message containing the number or URI dialed by the user.

The session request is a common session request containing no emergency identifier.

In Action 403, upon receiving the session request message, the CSCF determines whether the number or URI contained in the session request message matches its configured emergency number or emergency URI. If yes, Action 404 is performed; otherwise, the session is established according to the common session procedure, and the flowchart is terminated.

In Action 404, the CSCF selects, according to a local policy configured in the CSCF itself, the CS domain or the IMS domain as the network domain where the UE re-initiates an emergency call.

The local policy saved by the CSCF may be that the operator configures at the CSCF the information on whether the UE re-initiates an emergency call of CS domain or IMS domain according to whether the network supports only an emergency call of CS domain, or only an emergency call of IMS domain, or both of them. If the network side supports both an emergency call of CS domain and an emergency call of IMS domain, the operator may configure priority for the CS domain and the IMS domain, and the CSCF may select a domain with higher priority as the network domain where the UE re-initiates an emergency call.

In Action 405, the CSCF sends to the UE a session reject message containing indication information indicating re-initiating an emergency call of CS domain or IMS domain.

In Action 406, upon receiving the session reject message, the UE re-initiates an emergency call of CS domain or IMS domain according to the indication information, contained in the session reject message, for indicating re-initiating an emergency call of CS domain or IMS domain.

If the session reject message contains the indication information indicating re-initiating an emergency session of CS domain, the UE re-initiates an emergency call of CS domain. If the session reject message contains the indication information indicating re-initiating an emergency session of IMS domain, the UE re-initiates an emergency call of IMS domain.

If the UE re-initiates an emergency call of IMS domain, the detailed procedure is Actions 102-106 shown in FIG. 1.

The existing SIP 380 response message is an alternative-service message, and the alternative-service parameter of SIP 380 response message includes a type parameter and a reason sub-parameter. The type parameter has only one value “emergency”, which means instructing the UE to re-initiate an emergency call of CS domain. Therefore, the type parameter of 380 response message can be extended to realize the session reject message for indicating re-initiating an emergency call of CS domain or IMS domain. Specifically, the type parameter of 380 response message can be extended into two values “emergency” and “IMS emergency”. “Emergency” means instructing the UE to re-initiate an emergency call of CS domain and “IMS emergency” means instructing the UE to re-initiate an emergency call of IMS domain.

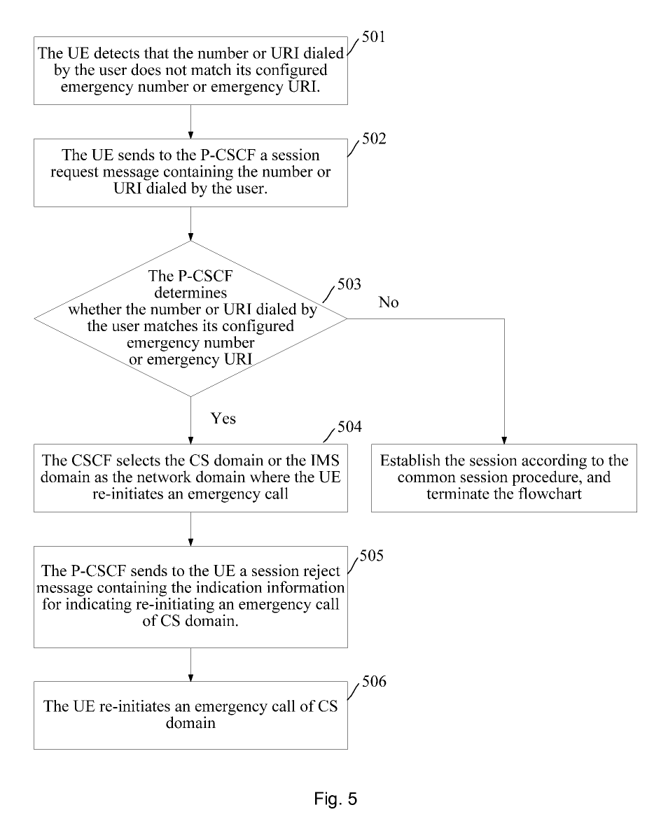

FIG. 5 is a flowchart of an emergency call when UE can not detect that a call initiated by a user is an emergency call in accordance with various embodiments. As shown in FIG. 5, the flowchart is described below.

In Action 501, upon detecting the number or URI dialed by a user, the UE detects that the number or URI does not match its configured emergency number or emergency URI.

In Action 502, the UE sends to the P-CSCF a session request message containing the number or URI dialed by the user.

The session request is a common session request, and the session request message contains no emergency identifier.

In Action 503, upon receiving the session request message, the P-CSCF determines whether the number or URI contained in the session request message matches its configured emergency number or emergency URI. If yes, Action 504 is performed; otherwise, the session is established according to the common session procedure, and the flowchart is terminated.

In Action 504, the P-CSCF selects, according to a local policy configured in the P-CSCF itself, the CS domain or the IMS domain as the network domain where the UE re-initiates an emergency call.

In Action 505, the P-CSCF sends to the UE a session reject message containing indication information indicating re-initiating an emergency call of CS domain or IMS domain.

In Action 506, upon receiving the session reject message, the UE re-initiates an emergency call of CS domain or IMS domain according to the indication information, contained in the session reject message, for indicating re-initiating an emergency call of CS domain or IMS domain.

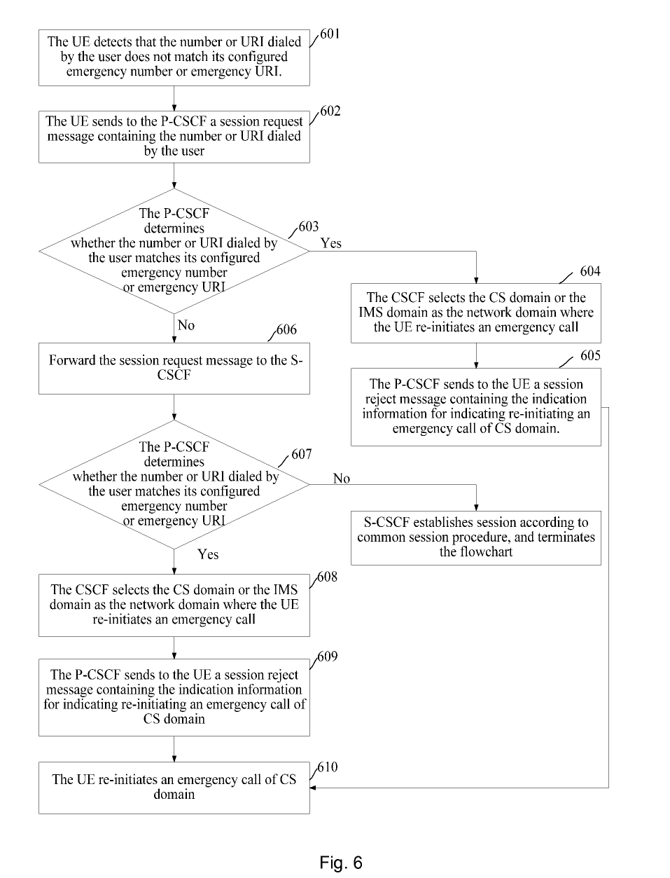

FIG. 6 is a flowchart of an emergency call when UE can not detect that a call initiated by a user is an emergency call in accordance with various embodiments. As shown in FIG. 6, the flowchart is described below.

In Action 601, upon detecting the number or URI dialed by a user, the UE detects that the number or URI does not match its configured emergency number or emergency URI.

In Action 602, the UE sends to the P-CSCF a session request message containing the number or URI dialed by the user.

The session request is a common session request, and the session request message contains no emergency identifier.

In Action 603, upon receiving the session request message, the P-CSCF determines whether the number or URI contained in the session request message matches its configured emergency number or emergency URI. If yes, Action 604 is performed; otherwise, Action 606 is performed.

In Action 604, the P-CSCF selects, according to a local policy configured in the P-CSCF, the CS domain or the IMS domain as the network domain where the UE re-initiates an emergency call.

In Action 605, the P-CSCF sends to the UE a session reject message containing indication information indicating re-initiating an emergency call of CS domain or IMS domain, and Action 610 is performed.

In Action 606, the P-CSCF forwards the session request message sent by the UE to the Service Call Session Control Function entity (S-CSCF).

In Action 607, upon receiving the session request message, the S-CSCF determines whether the number or URI contained in the session request message matches its configured emergency number or emergency URI. If yes, Action 608 is performed; otherwise, the session is established according to the common session procedure, and the flowchart is terminated.

In Action 608, the S-CSCF selects, according to a local policy configured in the S-CSCF, the CS domain or the IMS domain as the network domain where the UE re-initiates an emergency call.

In Action 609, the S-CSCF sends a session reject message containing indication information indicating re-initiating an emergency call of CS domain or IMS domain through the P-CSCF to the UE, and Action 610 is performed.

In Action 610, upon receiving the session reject message, the UE re-initiates an emergency call of CS domain or IMS domain according to the indication information, contained in the session reject message, for indicating re-initiating an emergency call of CS domain or IMS domain.

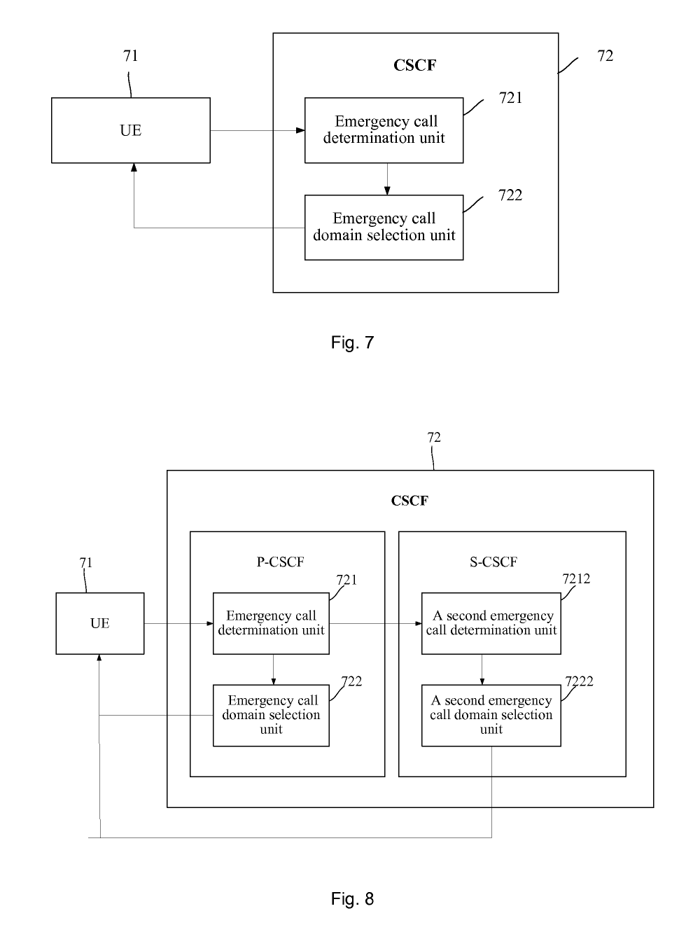

FIG. 7 is a block diagram illustrating a system for an emergency call in accordance with various embodiments. As shown in FIG. 7, the system mainly includes UE 71 and a CSCF 72, and the CSCF 72 includes an emergency call determination unit 721 and an emergency call domain selection unit 722.

The UE 71 is capable of sending a session request message to the emergency call determination unit 721, and re-initiating, upon receiving a session reject message sent by the emergency call domain selection unit 722, an emergency call of CS domain or IMS domain according to indication information which is contained in the session reject message and used for indicating re-initiating an emergency call of CS domain or IMS domain. The session request message contains the session request of the UE 71.

The emergency call determination unit 721 is capable of forwarding the session request message sent by the UE to the emergency call domain selection unit 722 upon determining that the session request containing no emergency identifier sent by the UE 71 is an emergency session request.

The emergency call domain selection unit 722 is capable of selecting, upon receiving the session request message sent by the emergency call determination unit 721, the CS domain or the IMS domain as the network domain where the UE re-initiates an emergency call according to a local policy configured by the emergency call domain selection unit 722, and sending to the UE 71 a session reject message containing the indication information indicating re-initiating an emergency call of CS domain or IMS domain.

In particular, the CSCF may be a P-CSCF.

FIG. 8 is a block diagram illustrating a system for an emergency call in accordance with various embodiments. As shown in FIG. 8, the system mainly includes UE 71 and a CSCF 72. The CSCF 72 includes a P-CSCF and an S-CSCF. The P-CSCF includes an emergency call determination unit 721 and an emergency call domain selection unit 722. The S-CSCF includes a second emergency call determination unit 7212 and a second emergency call domain selection unit 7222.

The UE 71 is capable of sending a session request message to the emergency call determination unit 721 of the P-CSCF, and re-initiating, upon receiving a session reject message sent by the emergency call domain selection unit 722 of the P-CSCF or by the second emergency call domain selection unit 7222 of the S-CSCF, an emergency call of CS domain or IMS domain according to indication information which is contained in the session reject message and used for indicating re-initiating an emergency all of CS domain or IMS domain.

The emergency call determination unit 721 is capable of forwarding the session request message sent by the UE to the emergency call domain selection unit 722 upon determining that the session request containing no emergency identifier sent by the UE 71 is an emergency session request; and forwarding the session request message sent by the UE 71 to the second emergency call determination unit 7212 upon determining that the session request containing no emergency identifier sent by the UE 71 is not an emergency session request.

The emergency call domain selection unit 722 is capable of selecting, upon receiving the session request message sent by the emergency call determination unit 721, the CS domain or the IMS domain as the network domain where the UE re-initiates an emergency call according to a local policy configured in the emergency call domain selection unit 722, and sending to the UE 71 a session reject message containing the indication information indicating re-initiating an emergency call of CS domain or IMS domain.

The second emergency call determination unit 7212 is capable of forwarding the session request message to the second emergency call domain selection unit 7222 of the S-CSCF upon determining that the session request containing no emergency identifier sent by the emergency call determination unit 721 of the P-CSCF is an emergency session request.

The second emergency call domain selection unit 7222 is capable of selecting, upon receiving the session request message sent by the emergency call determination unit 7212, the CS domain or the IMS domain as the network domain where the UE re-initiates an emergency call according to a local policy configured in the second emergency call domain selection unit 7222, and sending to the UE 71 a session reject message containing the indication information indicating re-initiating an emergency call of CS domain or IMS domain.

What is claimed is:

1. A method for an emergency call, comprising:
sending, by a Call Session Control Function entity (CSCF) to User Equipment (UE), a session reject message containing indication information indicating re-initiating an emergence call according to a local policy upon detecting that a session request sent by the UE is an emergency session request; and
re-initiating, by the UE, an emergency call of CS domain or Internet Protocol Multimedia Subsystem (IMS) domain according to the indication information.

2. The method of claim 1, wherein there is no emergency identifier in the session request.

3. The method of claim 1, wherein the re-initiating an emergency call of CS domain or IMS domain according to the indication information comprises:
re-initiating the emergency call of CS domain if detecting that the session reject message indicates re-initiating an emergency call of CS domain; and
re-initiating the emergency call of IMS domain if detecting that the session reject message indicates re-initiating an emergency call of IMS domain.

4. The method of claim 1, wherein the session reject message is a 380 response message defined in Session Initiation Protocol (SIP); and
a value of a type parameter included in an alternative-service parameter of the 380 response message comprises one of:
“emergency” indicating initiating an emergency call of CS domain and “IMS emergency” indicating initiating an emergency call of IMS domain.

5. The method of claim 1, wherein the CSCF is a Proxy-CSCF (P-CSCF).

6. The method of claim 1, wherein the CSCF comprises a Proxy-CSCF (P-CSCF) and a Service-CSCF (S-CSCF), the method further comprises:
forwarding, by the P-CSCF, to the S-CSCF, the session request sent by the UE upon receiving the session request sent by the UE in the case that the session request is not an emergency session request; and
sending, by the S-CSCF, to the UE the session reject message containing the indication information indicating re-initiating an emergency call according to the local policy upon receiving the session request and detecting that the session request is an emergency session request, wherein the UE re-initiates the emergency call of CS domain or IMS domain according to the indication information.

7. The method of claim 6, wherein the sending the session reject message containing the indication information indicating re-initiating an emergence call according to a local policy comprises:
selecting, by the S-CSCF according to priority of CS domain and IMS domain, a domain with higher priority as a network domain where the UE re-initiates an emergency call if the local policy is that a network supports both an emergency call of CS domain and an emergency call of IMS domain, and
sending the session reject message containing the indication information indicating re-initiating an emergency call of the selected domain.

8. The method of claim 1, wherein the sending the session reject message containing the indication information indicating re-initiating an emergence call according to a local policy comprises:
selecting, by the CSCF according to priority of CS domain and IMS domain, a domain with higher priority as a network domain where the UE re-initiates an emergency call if the local policy is that a network supports both an emergency call of CS domain and an emergency call of IMS domain, and
sending the session reject message containing the indication information indicating re-initiating an emergency call of the selected domain.

9. The method of claim 1, wherein the re-initiating an emergency call comprises:
if the indication information indicates re-initiating an emergency call of IMS domain, sending, by the UE to a Proxy-CSCF (P-CSCF), an emergency session request containing an emergency identifier;
sending, by the P-CSCF, the emergency session request to an Emergency-CSCF (E-CSCF);
forwarding, by the E-CSCF, the emergency session request to a Public Security Answer Point (PSAP) upon receiving the emergency session request;
sending, by the PSAP, a response message to the UE through the E-CSCF and P-CSCF upon receiving the emergency session request message; and
sending, by the UE, a response acknowledgement message to the PSAP through the P-CSCF and E-CSCF; wherein a emergency session is established after the PSAP receives the response acknowledgement message.

10. An emergency call system, comprising: User Equipment (UE) and a Call Session Control Function entity (CSCF), wherein the CSCF comprises: an emergency call determination unit and an emergency call domain selection unit;
the UE is configured to initiate a session request to the emergency call determination unit, and re-initiate an emergency call of CS domain or IMS domain according to a session reject message sent by the emergency call domain selection unit;
the emergency call determination unit is configured to forward the session request sent by the UE to the emergency call domain selection unit if determining that the session request initiated by the UE is an emergency session request;
the emergency call domain selection unit is configured to send the session reject message containing indication information indicating re-initiating an emergency call to the UE according to a local policy upon receiving the session request sent by the emergency call determination unit.

11. The system of claim 10, wherein the CSCF is a Proxy-CSCF (P-CSCF).

12. The system of claim 10, wherein the CSCF comprises: a Proxy-CSCF (P-CSCF) and a Service-CSCF (S-CSCF); and
the emergency call determination unit and the emergency call domain selection unit are located in the P-CSCF;
the S-CSCF comprises: a second emergency call determination unit and a second emergency call domain selection unit;
the emergency call determination unit is configured to forward the session request sent by the UE to the second emergency call determination unit of the S-CSCF if determining that the session request initiated by the UE is not an emergency session request;
the second emergency call determination unit is configured to forward the session request to the second emergency call domain selection unit of the S-CSCF if determining that the session request sent by the emergency call determination unit of the P-CSCF is an emergency session request; and
the second emergency call domain selection unit is configured to send the session reject message containing the indication information indicating re-initiating an emergency call to the UE according to the local policy upon receiving the session request sent by the second emergency call determination unit of the S-CSCF.
